(19) United States
(12) Patent Application Publication
(10) Pub. No.: US 2016/0283909 A1
(43) Pub. Date: Sep. 29, 2016

(54) TIME-AWARE MEETING NOTIFICATIONS

(71) Applicant: Cisco Technology, Inc., San Jose, CA (US)

(72) Inventor: Harsha S. Adiga, Bangalore (IN)

(21) Appl. No.: 14/667,569

(22) Filed: Mar. 24, 2015

(51) Int. Cl. G06Q 10/10; G06F 3/0484; H04L 12/18; G06F 3/0482

(52) U.S. Cl. CPC G06Q 10/1095; G06F 3/0482; G06F 3/0484; H04L 12/1818

(57) ABSTRACT

Methods and apparatus for providing an online meeting notification are provided. Embodiments of the system allow a computing device of an online meeting host to receive an electronic notification that a meeting participant has an overlapping meeting which starts before the scheduled ending time of the currently running online meeting. The system is configured to obtain calendar information of the participant's account associated with the online meeting system, and determine that the participant has the overlapping appointment that conflicts with the currently running online meeting. Upon determining that the overlapping meeting will occur within “N” minutes, the computing device can provide a meeting notification to the host computing device “N” minutes before the starting time of the overlapping appointment. The computing device of the meeting host can dismiss or snooze the meeting notification for bookmarked or individual participants.

### TECHNICAL FIELD

The present technology pertains to providing a meeting notification during a multi-way online meeting on computing devices. More particularly, the present disclosure relates to a method for notifying early leaving time of the participant of the online meeting during a live online meeting on the computing device.

### BACKGROUND

With dramatic advances in communication technologies, the advent of new techniques and functions in computing devices has steadily aroused consumer interest. In addition, various approaches to online meeting technology through user-interfaces have been introduced in the field of computing devices.

Conventional meetings can be in-person meetings, telephone conferencing meetings and/or online conference meetings. An online conference meeting allows users to connect to a meeting via the Internet. An online conference meeting, such as a WebEx™ meeting, can be referred to as web plus phone sharing or web conferencing. For example, users can participate via a telephone, smart phone, tablet, laptop and/or computer.

A common problem encountered in conventional meetings is attendance. Typically the participants can include one or more hosts, presenters, key audience members and/or regular audience members. Depending on which participants cannot attend the meeting, the meeting can go on as scheduled, postponed, or in some cases, never even occur. Even if the meeting goes on as scheduled, missing a participant or not having an important presenter when needed can impact the effectiveness of the meeting.

Many computing devices employ online meeting technology that many of the participants can join remotely through wireless connection. Often, a list of participants of the online meeting is provided to a host of the online meeting. However, the host may not know which participant of those participants has other overlapping appointments and need to drop a call in the middle of the current online meeting. It will be tedious and cumbersome to check each participant's calendar for their availabilities during the online meeting. If some of the participants drop the call during the online meeting before the host gets important information from that participant, then a purpose of having online meeting with many participants will be less fulfilled. Thus, as the online meeting technology is developed, a need to identify which participants have an upcoming conflicting event is increased to prioritize on the order of presentation to acquire important information is increased.

### BRIEF DESCRIPTION OF THE DRAWINGS

In order to describe the manner in which the above-recited and other advantages and features of the disclosure can be obtained, a more specific description of the principles briefly described above will be rendered by reference to specific embodiments thereof, which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram of an online meeting architecture in accordance with an example embodiment;

FIG. 2 illustrates an example online meeting accessed by a user;

FIGS. 3A and 3B illustrate an example online meeting interface layout that can be utilized on a computing device in accordance with various embodiments;

FIG. 4 illustrates a block diagram illustrating an example method for providing a notification on a computing device;

FIG. 5 illustrate an example interface layout of dismissing or snoozing the notification that can be utilized on a computing device in accordance with various embodiments;

FIGS. 6A and 6B illustrates an example bookmark interface layout that can be utilized on a computing device in accordance with various embodiments;

FIG. 7 illustrates an example setting interface layout that can be utilized on a computing device in accordance with various embodiments;

FIG. 8 illustrates an example network device; and

FIG. 9A and FIG. 9B illustrate example system embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

Disclosed are systems, methods, and computer-readable storage media for providing notifications during the online conference meeting. As one of ordinary skill in the art will readily recognize, the examples and technologies provided above are simply for clarity and explanation purposes, and can include many additional concepts and variations.

### Description

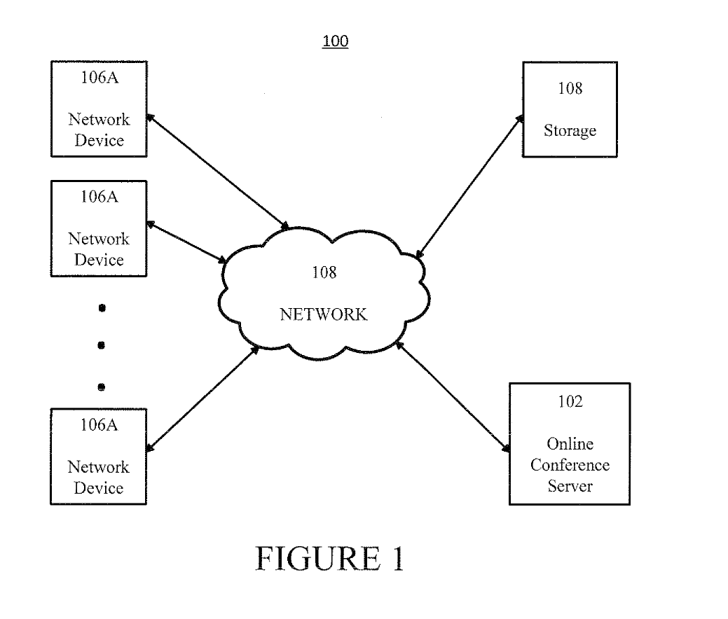

Referring to FIG. 1, a block diagram of an online conference meeting architecture in accordance with an exemplary embodiment is illustrated. As shown, the online conference meeting architecture 100 can include an online conference server 102, storage 104, network devices 106a, 106b . . . 106n (collectively referred to as “106”) and one or more networks 108. The online conference server 102 and storage 104 are shown as single components, but as known in the art, can be one or more components. The storage 104 can store content, such as documents, media items, or applications, which can be accessed by one or more network devices 106 via the one or more networks 108. For example, the online conference server 102 can comprise multiple servers. The online conference server 102 can service one or more discrete conferences. To this end, the online conference server 102 can enable one or more participants to communicate with the online conference server 102, as well as any of the network devices 106, to establish one or more conferences. Each conference can include one or more types of media, such as audio, video, text, and so forth. The online conference server 102 can implement various protocols to establish the conference with the network devices 106. For example, the online conference server 102 can implement Session Initiation Protocol (SIP) for signaling, HTTP, HTTPS, TCP, UDP, TLS, etc.

In some cases, the online conference server 102 can establish a communication session with each of the network devices 106 based on specific capabilities of each network device 106. Here, the online conference server 102 can use different protocols to communicate with the network devices 106 based on the settings or capabilities of each respective network device 106. For example, the online conference server 102 may use SIP to establish a communication session with network device 106a and otherwise establish a communication session with network device 106b using HTTP and TCP or UDP. The network devices 106 can include, but are not limited to, a telephone, a video conferencing client, a smartphone, a tablet computer, a laptop, a server, a conferencing system, or any other device that allows a participant to communicatively couple with the online conference server 102. Some participants can be communicatively coupled to the online conference server 102 via one or more devices, such as via a laptop and a telephone. The one or more networks 108 can include, for example, a public network, such a wide area network (WAN); a private network, such as a local area network (LAN); or a hybrid, such as a virtual private network (VPN).

The one or more networks 108 can be a geographically distributed collection of nodes interconnected by communication links and segments for transporting data between endpoints, such as personal computers and workstations. Many types of networks are available, with the types ranging from local area networks (LANs) and wide area networks (WANs) to overlay and software-defined networks, such as virtual extensible local area networks (VXLANs).

LANs typically connect nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links. LANs and WANs can include layer 2 (L2) and/or layer 3 (L3) networks and devices.

The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol can refer to a set of rules defining how the nodes interact with each other. Computer networks may be further interconnected by an intermediate network node, such as a router, to extend the effective “size” of each network.

Overlay networks generally allow virtual networks to be created and layered over a physical network infrastructure. Overlay network protocols, such as Virtual Extensible LAN (VXLAN), Network Virtualization using Generic Routing Encapsulation (NVGRE), Network Virtualization Overlays (NVO3), and Stateless Transport Tunneling (STT), provide a traffic encapsulation scheme which allows network traffic to be carried across L2 and L3 networks over a logical tunnel. Such logical tunnels can be originated and terminated through virtual tunnel end points (VTEPs).

Network segments, such as physical or virtual segments; networks; devices; ports; physical or logical links; and/or traffic in general can be grouped into a bridge or flood domain. A bridge domain or flood domain can represent a broadcast domain, such as an L2 broadcast domain. A bridge domain or flood domain can include a single subnet, but can also include multiple subnets. Moreover, a bridge domain can be associated with a bridge domain interface on a network device, such as a switch. A bridge domain interface can be a logical interface which supports traffic between an L2 bridged network and an L3 routed network. In addition, a bridge domain interface can support internet protocol (IP) termination, VPN termination, address resolution handling, MAC addressing, etc. Both bridge domains and bridge domain interfaces can be identified by a same index or identifier.

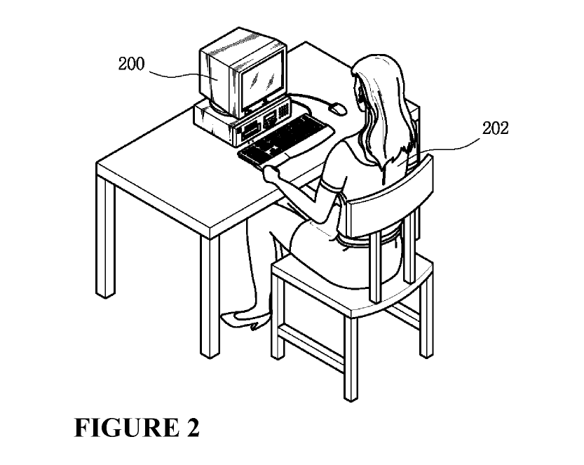

FIG. 2 shows an example of user 202 accessing the online meeting system using a first platform, which, in this example, is desktop computer 200. User 202 may have a user account associated with an online meeting system, such as WebEx™, which may be accessed via internet at the designated URL. User 202 can access the online meeting system on various computing devices such as desktop computer 200 as well as a laptop computer, a tablet computer, a mobile device, a smartphone, etc. The user device(s) may have the capability to communicate with the online meeting system via a network as illustrated in FIG. 1. User 202 can access his or her user account and its associated online meeting data by using a desktop application, such as a web browser, on her desktop computer 200. Although FIG. 2 shows user 202 as using desktop computer 200, one of ordinary skill in the art will understand that user 202 may also access online meeting system from other computing devices mentioned above. For example, user 202 may use a first access platform, such as desktop computer 200, to access the online meeting system, and then hop on to a second access platform, such as a mobile device, to continue accessing the online meeting system. In another example, user 202 can log on to the online meeting system on a dedicated client app on a tablet PC as the first access platform, but choose to continue the access on the same tablet PC's web browser as the second access platform. It may also be possible to access the online meeting system via the first access platform and the second access platform concurrently.

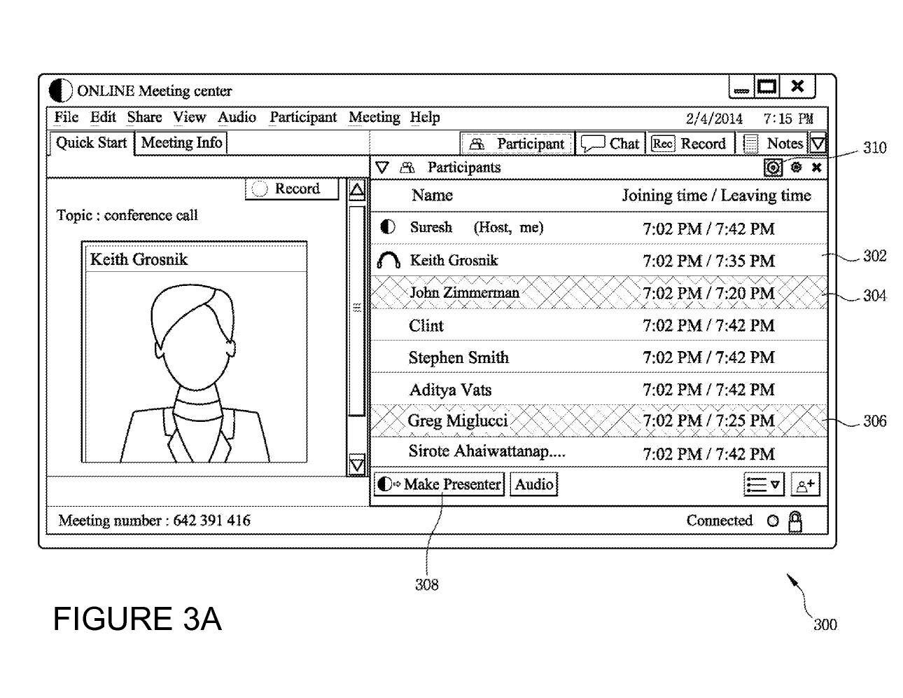

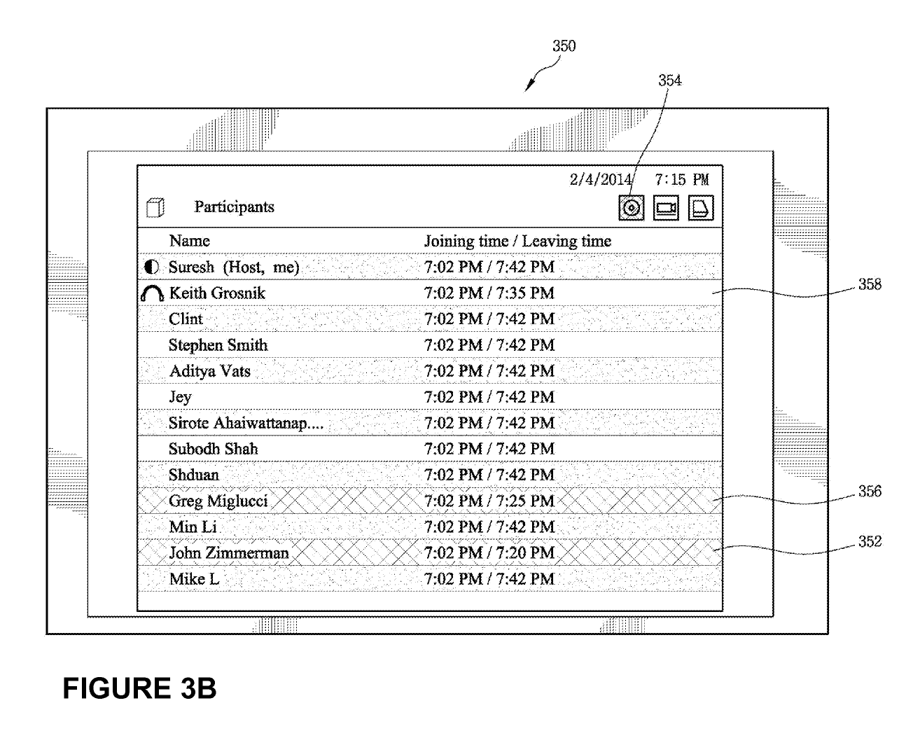

FIGS. 3A and 3B illustrate an example online meeting interface 300, 350. The online meeting center interface 300 may include information about a list of participants and a meeting topic. The list of the participants includes at least a name, joining time, and leaving time of each participant. For example, the list of participants includes names of all participants as illustrated in 300. A user account associated with the host is shown in FIG. 3A. In FIG. 3A, the host name, Suresh, is displayed on the top of the list of the participants. The icon next to the host name indicates that Suresh is the host. Under the host name, presenter's name 302 is displayed. In this example, Keith Grosnik is a presenter. A headphone icon next to his name indicates that Keith Grosnik is the presenter at this moment. The list of the participants includes other participants' name in the list such as Clint, Stephen Smith, or Aditya Vats.

In this example, the early leaving notification icon 310 is highlighted, because there is at least one person leaving the current online meeting before the scheduled ending time of the meeting. The scheduled ending time is 7:42 pm as indicated in 300. The participant John Jimmerman's name 304 and Greg Miglucci's name 306 are highlighted because their leaving times are before the scheduled ending time of the meeting (7:42 pm). John Zimmerman 304 is expected to leave at 7:20 pm and Greg Miglucci 306 is expected to leave at 7:25 pm. Thus, their names are highlighted and the host is able to tell that that these two participants will leave the current meeting within 5 minutes and 10 minutes respectfully. Accordingly, the host can switch the order of the presentation by making a next leaving person, John Zimmerman, a next presenter by clicking Make Presenter button 308 in the interface 300. This way, John Zimmerman will have a chance to present himself before he leaves the meeting. Greg Miglucci is also expected to leave the current meeting within 10 minutes at 7:25 pm. Greg Miglucci can be the second next presenter of this meeting. Since John Zimmerman is expected to leave the meeting before Greg Miglucci, John Zimmerman can have a chance to present himself before Greg Miglucci.

Keith Grosnik 302 is also expected to leave at 7:35 pm. However, Keith's name is not highlighted because Keith is not leaving within a pre-defined time (“N” minutes) the host has designated. In this example, the pre-defined time is 10 minutes, and anyone leaving within 10 minutes from the current time will be identified, and their names will be highlighted. Thus, even though Keith Grosnik is also leaving before the scheduled ending time (7:42 pm), Keith's name will not be highlighted until 7:25 pm.

The early leaving notification icon 310 is highlighted when there is at least one participant leaving within the pre-defined time (“N” minutes). The default “N” value is 10 minutes. In some embodiments, when the participant's name is not displayed on the screen (when the meeting interface 300 cannot capture every participant's name on one page), the early leaving notification icon 310 will be highlighted, and the host is able to tell that someone will be leaving the meeting soon, and thus, the host is able find the early leaving person from the list of participants. In this example, the early leaving notification icon 310 will be highlighted until the end of the meeting: current time is 7:15 pm, and John Zimmerman is leaving at 7:20 pm, Greg Miglucci is leaving at 7:25 pm, and Keith Grosnik is leaving at 7:35 pm, and the meeting ends at 7:42 pm.

In some embodiments, the early leaving notification 310 and the names of the early leaving participants 304, 306 can be highlighted on the other participants (Clint or Stephen Smith) meeting interface. Not only the host, but also other participants of the meeting can identify the early leaving participants and can actively interact with them before they leave the meeting.

The topic area in 300 shows relevant meeting information such as shared PowerPoint™ presentation or Word™ document. The topic area can further include graphical image such as a face of the current presenter, who, in this example, is a Keith Grosnik. If John Zimmerman is a next presenter, then his face will be displayed in the topic area, and thus, other participants can identify who is currently presenting. Other information related to the current meeting, such as a meeting ID number, or relevant meeting information such as a dial-in phone number can be displayed in the topic area.

FIG. 3B is an enlarged view 350 of the online meeting interface 300. In FIG. 3B, the list of participant area is enlarged for a better view. A list of participants of the online meeting is displayed in 350. A host, Suresh, and a presenter, Keith Grosnik 358, are identified. Two participants, Greg Miglucci 356 and John Zimmerman 352, whose leaving time are before the scheduled ending time of the meeting (7:42 pm) and within 10 minutes of the current time are identified and highlighted. The early leaving time notification 354 is highlighted to indicate that at least one participant will be leaving the current meeting within 10 minutes.

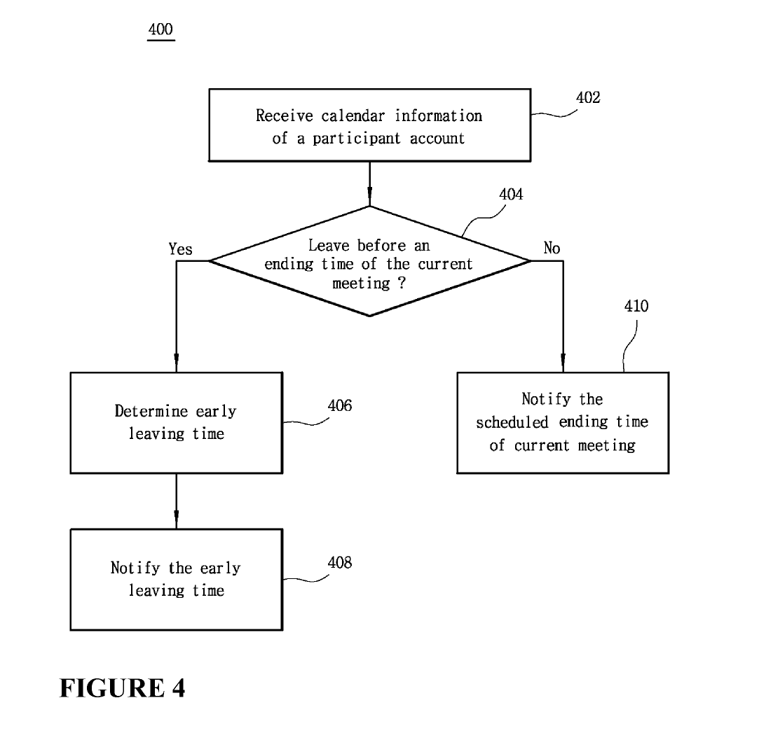

FIG. 4 illustrates a block diagram 400 illustrating an example method for providing a notification on a computing device. At 402, a main server receives calendar information of a participant account. The calendar information includes joining time and leaving time of the meeting of each participant. The joining time indicates the time that the participant account has joined the current meeting, and the leaving time is an estimated leaving time of the current meeting. The leaving time is often scheduled ending time of the current electronic meeting, however, when the participant device has a conflicting event that starts before the scheduled ending time of the current electronic meeting, and then the leaving time is no longer the scheduled leaving time. The leaving time will change to early leaving time, which is the starting time of the conflicting event.

The main server receives the calendar information real-time. Thus, when there is any change in the calendar information, the main server will receive the updated calendar information as the changes are made. Because the participant may accept or decline the invitation of the conflicting meeting as the current meeting is on. When the participant accepts the conflicting meeting invitation, then the leaving time of the participant is no longer the scheduled ending time of the current meeting, and will be changed to the early leaving time. The early leaving time is determined by the starting time of the conflicting event. The upcoming event is considered to be a conflicting meeting when the participant accepts a meeting invitation. If the participant does not accept the meeting invitation, it may not be considered as a conflicting meeting, and the host will not be notified of the early leaving time. When the upcoming event invitation is accepted by the participant, the calendar information will be fetched from the participant's outlook and forwarded to the host computer. The calendar information will be forwarded continuously and in real-time until the end of the current meeting. For example, if a participant accepts the upcoming event invitation during the meeting, the calendar information will be fetched in real time, so the host will not miss any important notification in case if the participant decides to leave during the current meeting.

In some embodiments, without accepting the conflicting meeting invitations, all participants can highlight themselves indicating that they will leave the current meeting within “N” minutes. If the participant needs to leave the current meeting due to other reasons, the participant may choose to send the early leaving time information manually to the host.

The host computer can receive calendar information from the main server, and determine whether the leaving time is before the scheduled ending time 404. Once the main server determines that the leaving time is the same as the scheduled ending time of the current meeting, then the main server will send the calendar information to the host computing device, and the host computing device can display each of the calendar information on the meeting interface 410. The meeting interface can include a list of the participant names, joining time, and determined leaving time as illustrated in FIG. 3A.

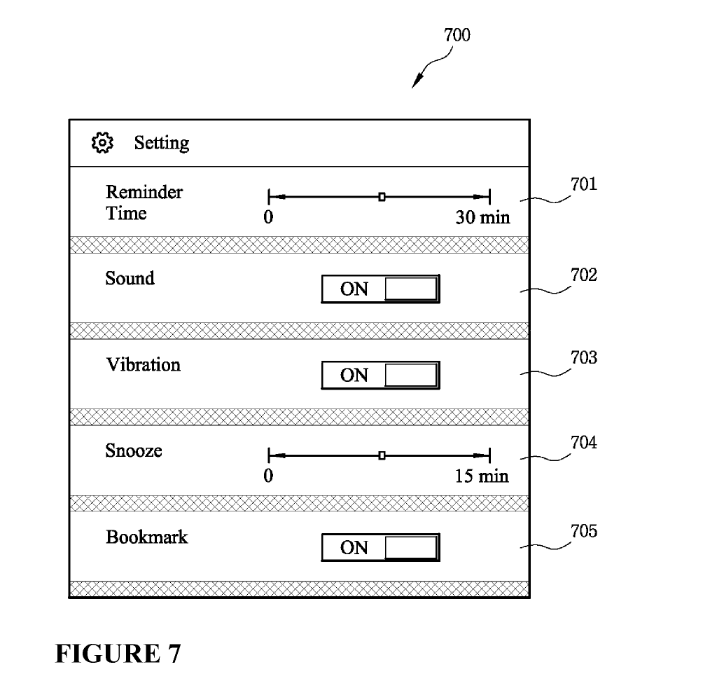

In some embodiments, the main server determines that the leaving time is before the scheduled meeting time, then the server will determine the early leaving time 406. As explained above, the early leaving time can be the starting time of the conflicting event or the time the participant designated as the early leaving time manually. When the early leaving time is determined, the host computing device will notify the early leaving time 408. The host computing device can notify the early leaving time “N” minutes before the early leaving time. The “N” minutes can be specified by the host in the setting as illustrated in FIG. 7. The default “N” minutes are 10 minutes. Thus, the host can be notified at least 10 minutes before the participant leaves the current meeting.

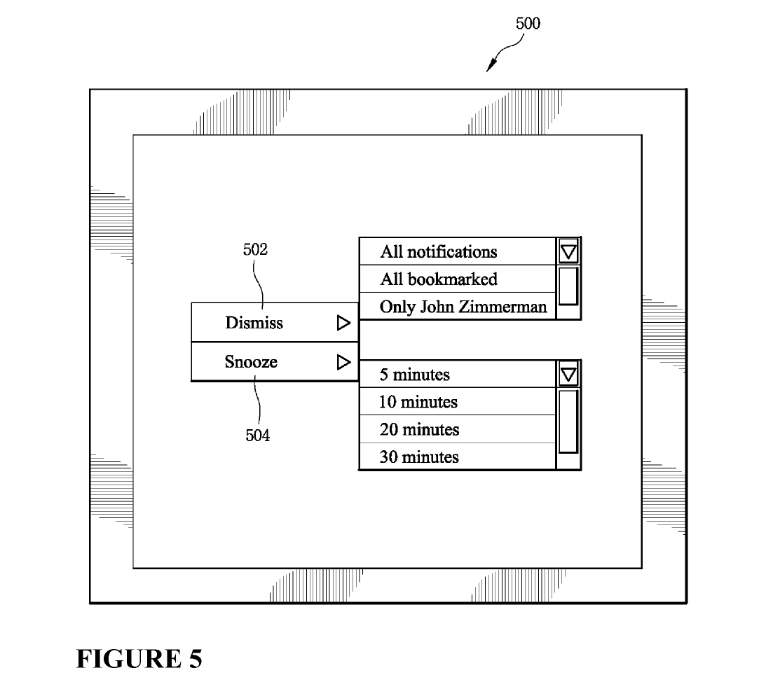

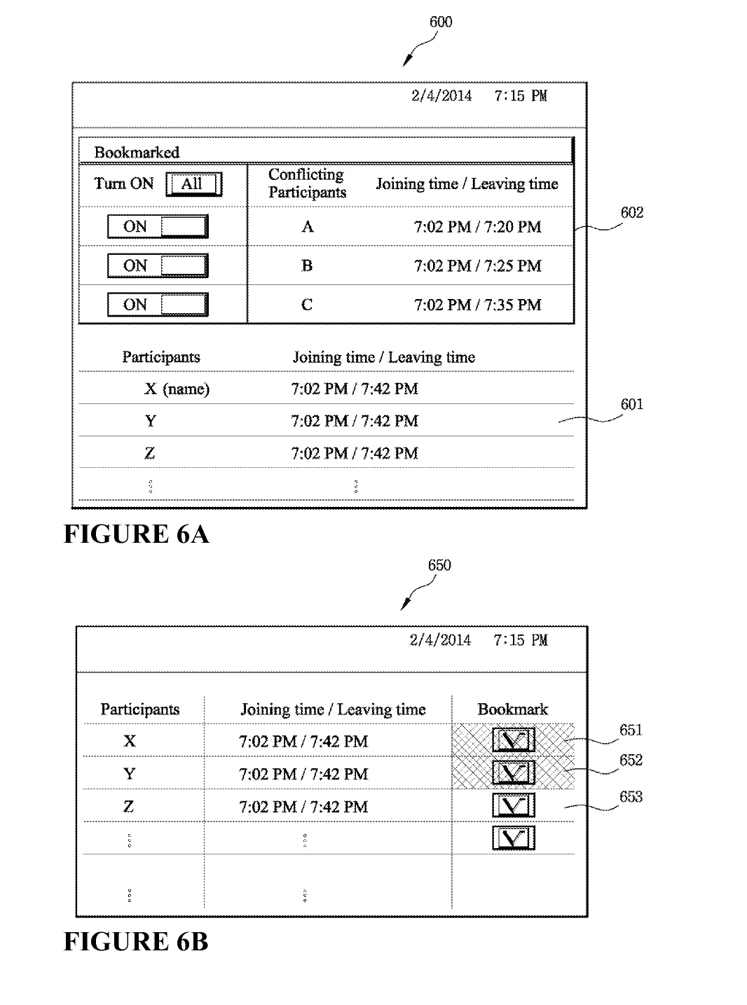

FIG. 5 illustrates an example dismiss and snooze interface layout 500 that can be utilized on a computing device in accordance with various embodiments. In some embodiments, the host can dismiss the early leaving time notification. If the host is the only presenter of the meeting and if the host does not want to be bothered by the multiple notifications highlighted on the interface, the host can simply dismiss the notification by turning the notification service off. A dismiss button 502 will be provided with the early leaving time notification when the early leaving time notification is displayed on the interface. The host can also turn the notification service on when needed. In some embodiments, the notification service can be dismissed for all participants. In some embodiments, the notification service can be dismissed for only bookmarked participants. Dismissing the early leaving time of the bookmarked participants will be discussed further with respect to the FIGS. 6A and 6B. In some embodiments, the notification service can be dismissed for each participant (in this example, John Zimmerman). By turning the notification service off for the participant John Zimmerman as illustrated in FIG. 5, the host will no longer receive the notification for the early leaving time of the participant John Jimmerman, however, the host will still receive early leaving time notifications of the other participants. Although it is not described in FIG. 5, if there are other participants who are expected to leave before the scheduled leaving time, the name of the participant will be displayed below “Only John Zimmerman” row.

The host can also snooze the notification for a specified period of time. If the host will be presenting for the next few minutes, and does not want to be bothered for the next few minutes, then the host can snooze the notification for the specified time period. The snooze function enables the host be reminded of the notification later. If the snooze time was set to be 10 minutes, the host will be notified of the early leaving time of a participant 10 minutes later.

The snooze notification can be displayed with multiple time options for the host to choose as illustrated in 504 in FIG. 5. For example, in FIG. 5, the host has four time options to choose: five minutes, ten minutes, twenty minutes, and thirty minutes. If the host can choose the five minutes time option, then the early leaving time of the participant will not be highlighted in the interface for five minutes, and will be displayed again after five minutes. The snooze notification can be convenient for the host when the host or a current presenter is the only presenter during the meeting, so when there is no need for changing the order of presentation. The host can also set the snooze time differently for each participant. For example, the host can set the snooze time for John Zimmerman for ten minutes, and snooze time for Greg Miglucci for twenty minutes. The snooze time can be changed by the host in the setting which will be explained further with respect to FIG. 7, or when the snooze notification pops up on the interface as illustrated in FIG. 5.

FIGS. 6A and 6B illustrate an example bookmark interface layout 600 that can be utilized on a computing device in accordance with various embodiments. The list of participants 601 are shown as well as the bookmarked list of participants 602 in the bookmark interface. The bookmark list can be used when the host wants to monitor the early leaving time of the particular participants of the meeting closely. Often, the important participants of the meeting can be selected for the bookmark participants. The host can add participants to a bookmark list in the bookmark interface 650 by clicking the Bookmark button 651, 652 in the interface. In FIG. 6B, participant X and Y are selected as the bookmarked participants and participant Z is not selected as the bookmarked participant 653.

In some embodiment, the list of bookmarked participants 602 will be displayed on the top of the list of participants 601 interface as illustrated in FIG. 6A. The host can further specify which bookmarked participant among the bookmarked participants the host is interested in monitoring the early leaving time, and can turn on the early leaving time notification for that specific participant as illustrated in 602 by clicking the TURN ON button associated with the specific participant. The list of bookmarked participants will be displayed in the order of the early leaving time. Thus, participant A is displayed before participant B and C, as the participant A is leaving before the participant B and C. The host can disable the early leaving time notification for all the bookmarked participants by clicking ALL button in the bookmark interface. The host can also disable the notification for the individual participant by turning off the notification service for the individual participant.

FIG. 7 illustrates an example setting interface layout 700 that can be utilized on a computing device in accordance with various embodiments. The setting can include multiple configurations that can be utilized on the computing device as shown in FIG. 7. Buttons may correspond to the various items of functionality displayed in screen of FIG. 7. In some embodiments, the host can decide how early the notification will be displayed on the screen. For example, the host can change the reminder time (“N” minutes) from 0 minute to 30 minutes 701. The reminder time was introduced as the “N” minutes with respect to FIG. 4 as above. The notification will appear on the screen “N” minutes before the early leaving time. For example, if the host sets the reminder time as 10 minutes, and the current time is 7:15 pm, then any participant expected to leave any time before 7:25 pm will be identified, and the name of that participant will be highlighted.

In some embodiments, the notification can be provided to the user in various forms. For example, the notification can be popped up on the screen as illustrated in FIG. 5 via a meeting notification interface, or the name of the early leaving participant can be highlighted as illustrated in FIG. 3A. The notification can be highlighted in a different color from the background color so it can be easily detected by the host. In some embodiments, the notification can be an audible reminder 702 or vibrating reminder 703. The notification can be displayed on the screen with the sound or vibrating reminder. If the silent mode is set on, there will be no sound or vibration. If silent mode if off, there will be sound or vibration along with the highlighting. The sound and the vibrating reminder can make the notifications detectable and easily spotted by the host. The host can change the type of the reminder in the setting as illustrated in 702 and 703.

In some embodiments, the host can change the length of the snooze time period 704 in the setting. The snooze function enables the host be reminded of the notification after “N” minutes which was set by the host. If the snooze time was set to be 10 minutes, the host will be notified of the early leaving time of a participant 10 minutes later. The snooze time period can be selected in the snooze interface as illustrated in FIG. 5. In some embodiment, the host can enable or disable the bookmark function 705 in the setting. If the host selects to use the bookmark function, the bookmark list will be displayed on the screen as illustrated in FIG. 6A.

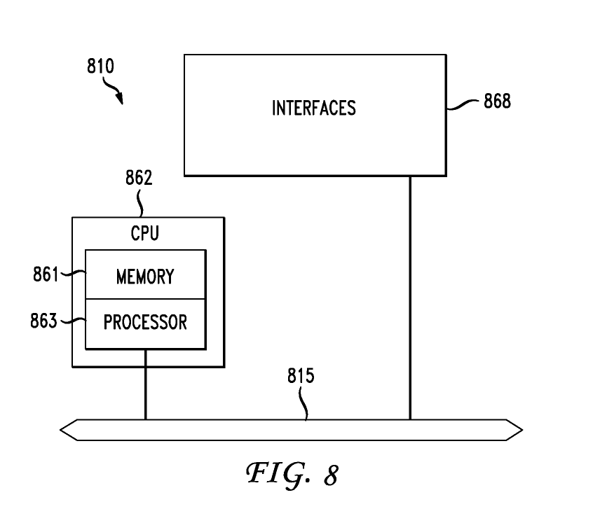

FIG. 8 illustrates an example network device 810. Network device 810 includes a master central processing unit (CPU) 862, interfaces 868, and a bus 815 (e.g., a PCI bus). When acting under the control of appropriate software or firmware, the CPU 862 is responsible for executing packet management, error detection, and/or routing functions, such as conferencing functions, for example. The CPU 862 preferably accomplishes all these functions under the control of software including an operating system and any appropriate applications software. CPU 862 may include one or more processors 863 such as a processor from the Motorola family of microprocessors or the MIPS family of microprocessors. In an alternative embodiment, processor 863 is specially designed hardware for controlling the operations of router 810. In a specific embodiment, a memory 861 (such as non-volatile RAM and/or ROM) also forms part of CPU 862. However, there are many different ways in which memory could be coupled to the system.

The interfaces 868 are typically provided as interface cards (sometimes referred to as “line cards”). Generally, they control the sending and receiving of data packets over the network and sometimes support other peripherals used with the router 810. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 862 to efficiently perform routing computations, network diagnostics, security functions, etc.

Although the system shown in FIG. 8 is one specific network device of the present invention, it is by no means the only network device architecture on which the present invention can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 861) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc.

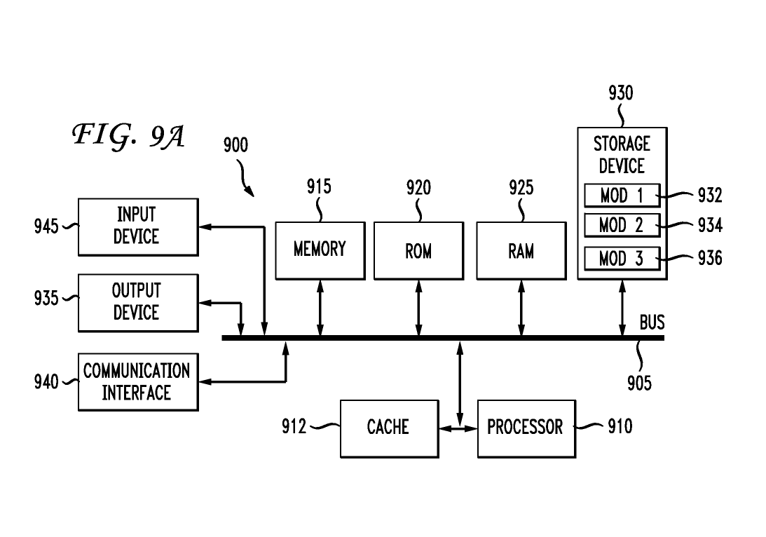

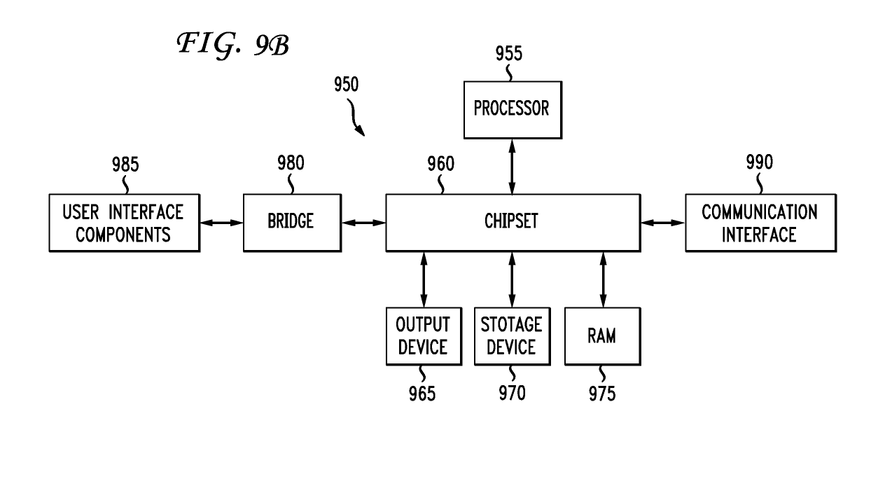

FIG. 9A and FIG. 9B illustrate example system embodiments. The more appropriate embodiment will be apparent to those of ordinary skill in the art when practicing the present technology. Persons of ordinary skill in the art will also readily appreciate that other system embodiments are possible.

FIG. 9A illustrates a conventional system bus computing system architecture 900 wherein the components of the system are in electrical communication with each other using a bus 905. Exemplary system 900 includes a processing unit (CPU or processor) 910 and a system bus 905 that couples various system components including the system memory 915, such as read only memory (ROM) 970 and random access memory (RAM) 975, to the processor 910. The system 900 can include a cache of high-speed memory connected directly with, in close proximity to, or integrated as part of the processor 910. The system 900 can copy data from the memory 915 and/or the storage device 930 to the cache 917 for quick access by the processor 910. In this way, the cache can provide a performance boost that avoids processor 910 delays while waiting for data. These and other modules can control or be configured to control the processor 910 to perform various actions. Other system memory 915 may be available for use as well. The memory 915 can include multiple different types of memory with different performance characteristics. The processor 910 can include any general purpose processor and a hardware module or software module, such as module 1 937, module 7 934, and module 3 936 stored in storage device 930, configured to control the processor 910 as well as a special-purpose processor where software instructions are incorporated into the actual processor design. The processor 910 may essentially be a completely self-contained computing system, containing multiple cores or processors, a bus, memory controller, cache, etc. A multi-core processor may be symmetric or asymmetric.

To enable user interaction with the computing device 900, an input device 945 can represent any number of input mechanisms, such as a microphone for speech, a touch-sensitive screen for gesture or graphical input, keyboard, mouse, motion input, speech and so forth. An output device 935 can also be one or more of a number of output mechanisms known to those of skill in the art. In some instances, multimodal systems can enable a user to provide multiple types of input to communicate with the computing device 900. The communications interface 940 can generally govern and manage the user input and system output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 975, read only memory (ROM) 970, and hybrids thereof.

The storage device 930 can include software modules 937, 934, 936 for controlling the processor 910. Other hardware or software modules are contemplated. The storage device 930 can be connected to the system bus 905. In one aspect, a hardware module that performs a particular function can include the software component stored in a computer-readable medium in connection with the necessary hardware components, such as the processor 910, bus 905, display 935, and so forth, to carry out the function.

FIG. 9B illustrates an example computer system 950 having a chipset architecture that can be used in executing the described method and generating and displaying a graphical user interface (GUI). Computer system 950 is an example of computer hardware, software, and firmware that can be used to implement the disclosed technology. System 950 can include a processor 955, representative of any number of physically and/or logically distinct resources capable of executing software, firmware, and hardware configured to perform identified computations. Processor 955 can communicate with a chipset 960 that can control input to and output from processor 955. In this example, chipset 960 outputs information to output 965, such as a display, and can read and write information to storage device 970, which can include magnetic media, and solid state media, for example. Chipset 960 can also read data from and write data to RAM 975. A bridge 980 for interfacing with a variety of user interface components 985 can be provided for interfacing with chipset 960. Such user interface components 985 can include a keyboard, a microphone, touch detection and processing circuitry, a pointing device, such as a mouse, and so on. In general, inputs to system 950 can come from any of a variety of sources, machine generated and/or human generated.

Chipset 960 can also interface with one or more communication interfaces 990 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 955 analyzing data stored in storage 970 or 975. Further, the machine can receive inputs from a user via user interface components 985 and execute appropriate functions, such as browsing functions by interpreting these inputs using processor 955.

It can be appreciated that example systems 900 and 950 can have more than one processor 910 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

1. A computer-implemented method comprising:
receiving calendar information associated with a participant account in a current electronic meeting;
determining an early leaving time that the participant account will leave the current electronic meeting due to a conflicting event in the calendar information, the conflicting event beginning before an ending time of the current electronic meeting; and
notifying one or more other participant accounts of the current electronic meeting of the determined early leaving time of the participant account.

2. The computer-implemented method of claim 1, wherein the conflicting event is an upcoming meeting accepted by the participant account.

3. The computer-implemented method of claim 1, wherein the calendar information includes joining time, the joining time is a time the participant account has joined the current electronic meeting.

4. The computer-implemented method of claim 1, wherein the calendar information further includes scheduled leaving time, the scheduled leaving time is the ending time of the current electronic meeting.

5. The computer-implemented method of claim 1, further comprising:
receiving information that the participant account has accepted an invitation to the conflicting event during the current electronic meeting;
automatically determining the early leaving time of the participant account; and
notifying one or more other participant accounts of the current electronic meeting of the determined early leaving time of the participant account.

6. The computer-implemented method of claim 1, further comprising:
receiving a request, from the participant account, to provide a notification including the early leaving time to the one or more participant accounts.

7. The computer-implemented method of claim 1, further comprising:
receiving an indication, via a first graphical interface, to dismiss the notification of the determined early leaving time.

8. The computer-implemented method of claim 1, further comprising:
receiving an indication, via a second graphical interface, to snooze the notification of the determined early leaving time for a specified period of time.

9. A system comprising:
a processor;
a memory device including instructions that, when executed by the processor, enables a computing device to:
receive calendar information associated with a participant account in a current electronic meeting;
determine an early leaving time that the participant account will leave the current electronic meeting due to a conflicting event in the calendar information, the conflicting event beginning before an ending time of the current electronic meeting; and
notify one or more other participant accounts of the current electronic meeting of the determined early leaving time of the participant account.

10. The system of claim 9, wherein the conflicting event is an upcoming meeting accepted by the participant account.

11. The system of claim 9, wherein the calendar information includes joining time, the joining time is a time the participant account has joined the current electronic meeting.

12. The system of claim 9, wherein the calendar information further includes scheduled leaving time, the scheduled leaving time is the ending time of the current electronic meeting.

13. The system of claim 9, wherein the instructions when executed by the processor, further enables the computing device to:
receive information that the participant account has accepted an invitation to the conflicting event during the current electronic meeting;
automatically determine the early leaving time of the participant account; and
notify one or more other participant accounts of the current electronic meeting of the determined early leaving time of the participant account.

14. The system of claim 9, wherein the instructions when executed by the processor, further enables the computing device to:
determine a list of participants that will leave the current electronic meeting before the scheduled ending time due to the conflicting event; and
display, via a first interface, the list of participants in an order of a starting time of the conflicting event.

15. A non-transitory computer-readable storage medium storing instructions, when executed by a processor of a computing device, causes the computing device to:
receive calendar information associated with a participant account in a current electronic meeting;
determine an early leaving time that the participant account will leave the current electronic meeting due to a conflicting event in the calendar information, the conflicting event beginning before an ending time of the current electronic meeting; and
notify one or more other participant accounts of the current electronic meeting of the determined early leaving time of the participant account.

16. The non-transitory computer-readable storage medium of claim 15, wherein the instructions, further causes the computing device to:
receive a request, from the participant account, to provide a notification including the early leaving time to the one or more participant accounts.

17. The non-transitory computer-readable storage medium of claim 15, wherein the instructions, further causes the computing device to:
receive an indication, via a first graphical interface, to dismiss the notification of the determined early leaving time.

18. The non-transitory computer-readable storage medium of claim 15, wherein the instructions, further causes the computing device to:
receive an indication, via a second graphical interface, to snooze the notification of the determined early leaving time for a specified period of time.

19. The non-transitory computer-readable storage medium of claim 15, wherein the instructions, further causes the computing device to:
identify a list of bookmarked participants for the current electronic meeting, the list of bookmarked participants is selected by at least one or more participant accounts; and
display, via a third graphical interface, the list of bookmarked participants in a prioritized order.

20. The non-transitory computer-readable storage medium of claim 15, wherein the one or more participant accounts are notified of the early leaving time a specified period of time before a starting time of the conflicting event.
